(19) United States
(12) Patent Application Publication
(10) Pub. No.: US 2025/0379404 A1
(43) Pub. Date: Dec. 11, 2025

(54) ELECTRICAL CONNECTOR

(71) Applicant: LOTES CO., LTD, Keelung (TW)

(72) Inventors: Wen-Chang Chang, Keelung (TW); Qui-Shen Feng, Guangzhou (CN); Jie Wang, Guangzhou (CN)

(21) Appl. No.: 19/226,376

(22) Filed: Jun. 3, 2025

(30) Foreign Application Priority Data
Jun. 6, 2024 (CN) 202410728968.X

(51) Int. Cl. H01R 13/6471; H01R 12/70; H01R 13/6581

(52) U.S. Cl. CPC H01R 13/6471; H01R 12/7005; H01R 13/6581

(57) ABSTRACT

An electrical connector includes a terminal unit. The terminal unit includes at least one signal terminal and a first ground terminal and a second terminal provided to be adjacent to the at least one signal terminal. A first grounding sheet includes a first connecting portion and a second connecting portion. The first connecting portion and the second connecting portion correspondingly connected to the first ground terminal and the second ground terminal at least partially overlap along a left-right direction. A distance between the first connecting portion and a closest signal terminal is not equal to a distance between the second connecting portion and a closest signal terminal, or an area of a surface of each of the first connecting portion and the second connecting portion adjacent to the signal terminal along the left-right direction is not equal. Thus, the superposition issue is prevented when resonant frequencies coincide.

### CROSS-REFERENCE TO RELATED PATENT APPLICATION

This non-provisional application claims priority to and the benefit of, pursuant to 35 U.S.C. § 119 (a), patent application Serial No. CN202410728968.X, filed in China on Jun. 6, 2024. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to an electrical connector, and particularly to an electrical connector in which the grounding sheet is changed, thereby reducing the resonance.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In the existing technology, an electrical connector includes an insulating body, a row of terminals provided in the insulating body and a grounding member corresponding to the row of terminals. FIG. 10 and FIG. 11 are schematic views of a row of terminals 2′ and the grounding member 3′ of an electrical connector in the prior art. The row of terminals are arranged along a left-right direction and include a plurality of signal terminals S′ and a plurality of ground terminals G′. Each of a left side and a right side of at least one of the signal terminals S′ has an adjacent ground terminal G′, and the two ground terminals G′ are provided to be structurally symmetrical at two sides of at least one of the signal terminal S′. To improve the shielding effect inside the electrical connector and reduce the noise and interference between the signal terminals S′, those skilled in the art typically provide a grounding member 3′ adjacent to a row of terminals within the electrical connector. Each ground terminal G′ includes a flat plate section 21′, an elastic arm 22′ bending from and connected to a front end of the flat plate section 21′, a connecting section 23′ bending and extending downward from a rear end of the flat plate section 21′ and a conductive portion 24′ bending from and connected to the connecting section 23′. The grounding member 3′ includes a plurality of first abutting portions 31′ with identical structures and a plurality of second abutting portions 32′ with identical structures. The first abutting portions 31′, the second abutting portions 32′ and the ground terminals G′ are provided to be correspondingly in contact. In addition, the first abutting portions 31′ connect the ground terminals G′ in series at the same locations of the corresponding flat plate sections 21′, and the second abutting portions 32′ connect the ground terminals G′ in series at the same locations of the corresponding connecting sections 23′.

FIG. 12 is a chart showing resonance analysis of far-end crosstalk (FEXT) of an electrical connector in the prior art. The dashed line curve a′ and the dashed line curve b′ represent the resonance curves of two ground terminals G′ at the two sides of at least one signal terminal, respectively, and the solid line curve c′ represents the superposition of the resonance curves of the two ground terminals G′ at the two sides of the at least one signal terminal S′. From the analysis chat, it can be seen that in the frequency range of 15-20 GHz, the abrupt peaks of the brown curve and the red curve have the same value on the horizontal axis (frequency), and both exceed −50 dB on the vertical axis (resonance). The abrupt peak of the black curve exceeds −45 dB on the vertical axis (resonance). The resonant frequency point of the signal terminal S′ of the electrical connector is more capacitive, and it is clearly seen from FIG. 12 that the coordinates of the abrupt peaks of the resonant frequency of the ground terminals G′ at the two sides of the signal terminal S′ have the same value on the horizontal axis and have higher resonance amplitude values on the vertical axis, thus resulting in the superposition of the abrupt peaks in the FEXT test curve of the electrical connector, and increasing the resonance thereof, such that the signal transmission of the electrical connector fails to meet the expected effect.

Therefore, a heretofore unaddressed need to design a new electrical connector exists in the art to address the aforementioned deficiencies and inadequacies.

### SUMMARY

In view of the deficiencies of the background technology, the present invention is directed to an electrical connector, which has a grounding sheet with connecting portions having different structures, such that the two ground terminals at two sides of at least one signal terminal are connected to connecting portions with different structures, thereby improving the resonance.

To achieve the foregoing objective, in certain aspects of the present invention, an electrical connector includes: an insulating body; a first terminal group provided in the insulating body, wherein the first terminal group is arranged along a left-right direction and comprises at least one terminal unit, the terminal unit comprises a first ground terminal, a second ground terminal and at least one signal terminal located between the first ground terminal and the second ground terminal along the left-right direction; and a first grounding sheet, electrically connected to the first ground terminal and the second ground terminal, wherein the first grounding sheet comprises at least one first connecting portion and at least one second connecting portion, the first connecting portion is electrically connected to the first ground terminal, and the second connecting portion is electrically connected to the second ground terminal; wherein in one of the at least one terminal unit, the first connecting portion and the second connecting portion electrically connected to the first ground terminal and the second ground terminal at least partially overlap along the left-right direction, a distance between the first connecting portion and a closest one of the at least one signal terminal in the left-right direction is not equal to a distance between the second connecting portion and a closest one of the at least one signal terminal in the left-right direction, or an area of a surface of the first connecting portion at a side adjacent to the at least one signal terminal along the left-right direction is not equal to an area of a surface of the second connecting portion at a side adjacent to the at least one signal terminal along the left-right direction.

In certain embodiments, the first connecting portion and the second connecting portion are flat plate structures extending in the front-rear direction, the first connecting portion is in surface contact with the first ground terminal, the second connecting portion is in surface contact with the second ground terminal, and an extending length of the first connecting portion in the front-rear direction is greater than an extending length of the second connecting portion in the front-rear direction.

In certain embodiments, the distance between the first connecting portion and the closest one of the at least one signal terminal in the left-right direction is less than the distance between the second connecting portion and the closest one of the at least one signal terminal in the left-right direction.

In certain embodiments, a width of the first connecting portion in the left-right direction is greater than a width of the second connecting portion in the left-right direction.

In certain embodiments, the first ground terminal and the second ground terminal have identical structures, each of the first ground terminal and the second ground terminal comprises a first flat plate section, a first elastic arm formed by bending and extending from a front end of the first flat plate section, a first connecting section formed by bending and extending from a rear end of the first flat plate section and a first conductive portion connected to the first connecting section, the first conductive portion is exposed out of the insulating body to be electrically connected to a circuit board, a portion of the first flat plate section of each of the first ground terminal and the second ground terminal configured to be respectively in contact with the first connecting portion and the second connecting portion is defined as a connecting region, the connecting region has a first dimension in the left-right direction, a dimension of the first connecting portion in the left-right direction is greater than the first dimension corresponding to the first connecting portion, and a dimension of the second connecting portion in the left-right direction is not greater than the first dimension corresponding to the second connecting portion.

In certain embodiments, a maximum width of a portion of the signal terminal overlapping with the connecting region of the first ground terminal along the left-right direction is defined as a second dimension, and the second dimension is greater than the first dimension corresponding to the first connecting portion.

In certain embodiments, the first terminal group is insert-molded to an insulating block, the insulating block comprises a first plastic slot provided to correspond to the first ground terminal and a second plastic slot provided to correspond to the second ground terminal in a vertical direction, and widths of the first plastic slot and the second plastic slot in the left-right direction or lengths of the first plastic slot and the second plastic slot in the front-rear direction are different from each other.

In certain embodiments, each of the first ground terminal and the second ground terminal comprises a first flat plate section, a first elastic arm formed by bending and extending from a front end of the first flat plate section and a first connecting section formed by bending and extending from a rear end of the first flat plate section, a bending portion between the first flat plate section and the first connecting section is defined as a first bending portion, the first bending portion of the first ground terminal is exposed in the first plastic slot, and the first bending portion of the second ground terminal is exposed in the second plastic slot.

In certain embodiments, the first connecting portion is in contact with the first flat plate section of the first ground terminal, the second connecting portion is in contact with the first flat plate section of the second ground terminal, the first connecting portion is farther away from the first elastic arm relative to the first bending portion of the first bending portion of the first ground terminal, and the second connecting portion is farther away from the first elastic arm relative to the first bending portion of the second ground terminal.

In certain embodiments, a width of the first connecting portion in the left-right direction is greater than a width of the second connecting portion in the left-right direction, the first ground terminal and the second ground terminal are respectively exposed in the first plastic slot and the second plastic slot, and a width of the first plastic slot in the left-right direction is greater than a width of the second plastic slot in the left-right direction or a length of the first plastic slot in the front-rear direction is greater than a length of the second plastic slot in the front-rear direction.

In certain embodiments, the at least one signal terminal comprises a differential terminal pair formed by two differential signal terminals, in the differential terminal pair, one of the two differential signal terminals adjacent to the first ground terminal is defined as a first signal terminal, and the other of the two differential signal terminals adjacent to the second ground terminal is defined as a second signal terminal; or the at least one signal terminal is a single-ended signal terminal, and the single-ended signal terminal is located between the first ground terminal and the second ground terminal.

In certain embodiments, the electrical connector further includes a second terminal group, provided in the insulating body, wherein the second terminal group is arranged along the left-right direction, the second terminal group comprises a plurality of third ground terminals, each of the first ground terminal and the second ground terminal comprises a first flat plate section, a first elastic arm bending and extending from a front end of the first flat plate section, a first connecting section bending and extending from a rear end of the first flat plate section and a first conductive portion bending from and connected to the first connecting section, the first conductive portion is exposed out of the insulating body to be electrically connected to a circuit board, each of the third ground terminals comprises a second flat plate section, a second elastic arm bending and extending from a front end of the second flat plate section, a second connecting section bending and extending from a rear end of the second flat plate section and a second conductive portion bending from and connected to the second connecting section, the second conductive portion is exposed out of the insulating body to be electrically connected to a circuit board, the first flat plate section is located above the second flat plate section, the first flat plate section and the second flat plate section are provided opposite to each other in a vertical direction, the first conductive portion is located behind the second conductive portion, the first conductive portion and the second conductive portion are provided opposite to each other in the front-rear direction, the first grounding sheet is provided between the first terminal group and the second terminal group, and the first grounding sheet is in contact with the first ground terminal and the second ground terminal and is not in contact with the third ground terminals.

To achieve the foregoing objective, in certain aspects of the present invention, a grounding sheet structure in an electrical connector is provided, the grounding sheet includes: a first plate portion; and at least one first connecting portion and at least one second connecting portion extending from the first plate portion, wherein the first connecting portion and the second connecting portion are electrically connected to a ground terminal of the electrical connector respectively, and the first connecting portion and the second connecting portion are arranged along a left-right direction; wherein viewing along a vertical direction, locations of at least one portion of the first connecting portion and at least one portion of the second connecting portion are identical in a front-rear direction, an extending length of the first connecting portion in the front-rear direction and an extending length of the second connecting portion in the front-rear direction are not identical, or a width of the first connecting portion in the left-right direction and a width of the second connecting portion in the left-right direction are not identical.

In certain embodiments, the first connecting portion and the second connecting portion are flat plate structures to be in surface contact with the ground terminals of the electrical connector, and the extending length of the first connecting portion in the front-rear direction is greater than the extending length of the second connecting portion in the front-rear direction.

In certain embodiments, a width of the first connecting portion in the left-right direction is greater than a width of the second connecting portion in the left-right direction.

In certain embodiments, a dimension of the first connecting portion in the left-right direction is greater than a dimension of the ground terminal connected to the first connecting portion in the left-right direction, and a dimension of the second connecting portion in the left-right direction is less than or equal to a dimension of the ground terminal connected to the second connecting portion in the left-right direction.

To achieve the foregoing objective, in certain aspects of the present invention, an electrical connector includes: an insulating body; a first terminal group provided in the insulating body, wherein the first terminal group is arranged along a left-right direction and comprises at least one terminal unit, the terminal unit comprises a first ground terminal, a second ground terminal and at least one signal terminal located between the first ground terminal and the second ground terminal along the left-right direction; and a first grounding sheet, comprising at least one first connecting portion and at least one second connecting portion, wherein the first connecting portion is electrically connected to the first ground terminal, and the second connecting portion is electrically connected to the second ground terminal; wherein at least one portion of the first connecting portion and at least one portion of the second connecting portion electrically connected to the first ground terminal and the second ground terminal in one of the at least one terminal unit are located at a same height in a vertical direction, a distance between the first connecting portion and a closest one of the at least one signal terminal in the left-right direction is not equal to a distance between the second connecting portion and a closest one of the at least one signal terminal in the left-right direction, or an extending length of the first connecting portion in the front-rear direction and an extending length of the second connecting portion in a front-rear direction are not identical.

In certain embodiments, the first connecting portion and the second connecting portion are flat plate structures extending in the front-rear direction, the first connecting portion is in surface contact with the first ground terminal, the second connecting portion is in surface contact with the second ground terminal, and the extending length of the first connecting portion in the front-rear direction is greater than the extending length of the second connecting portion in the front-rear direction.

In certain embodiments, a width of the first connecting portion in the left-right direction is greater than a width of the second connecting portion in the left-right direction.

In certain embodiments, the first ground terminal and the second ground terminal have identical structures, a portion of each of the first ground terminal and the second ground terminal configured to be respectively in contact with the first connecting portion and the second connecting portion is defined as a connecting region, the connecting region has a first dimension in the left-right direction, a dimension of the first connecting portion in the left-right direction is greater than the first dimension corresponding to the first connecting portion, and a dimension of the second connecting portion in the left-right direction is not greater than the first dimension corresponding to the second connecting portion.

In certain embodiments, a maximum width of a portion of the signal terminal overlapping with the connecting region of the first ground terminal along the left-right direction is defined as a second dimension, and the second dimension is greater than the first dimension.

Compared to the related art, the present invention has the following beneficial effects: the first connecting portion and the second connecting portion electrically connected to the first ground terminal and the second ground terminal at least partially overlap along the left-right direction, a distance between the first connecting portion and a closest one of the at least one signal terminal in the left-right direction is not equal to a distance between the second connecting portion and a closest one of the at least one signal terminal in the left-right direction, or an area of a surface of the first connecting portion at a side adjacent to the at least one signal terminal along the left-right direction is not equal to an area of a surface of the second connecting portion at a side adjacent to the at least one signal terminal along the left-right direction, such that the first ground terminal and the second ground terminal have different resonant frequencies, and in the FEXT test curve, the resonance amplitude values on the vertical axis are less than the resonance amplitude values of the electrical connector in the prior art. In addition, the frequencies of the abrupt peaks of the FEXT curves of the electrical connector are different from each other, thus preventing from the superposition of the abrupt peaks of the FEXT curves on the same frequency point that affects the signal transmission, and ensuring the signal transmission of the electrical connector.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a perspective view of an electrical connector according to certain embodiments of the present invention.

FIG. 2 is a sectional view of FIG. 1 sectioned along a plain limited by the Y-axis and the Z-axis after the electrical connector is mounted to a circuit board.

FIG. 3 is a schematic view of FIG. 2, in which only the first terminal group, the second group, the first grounding sheet and the second grounding sheet are reserved.

FIG. 4 is a bottom view of FIG. 3, in which only the first terminal group and the first grounding sheet are partially shown.

FIG. 5 is a perspective exploded view of the electrical connector in FIG. 1 in another viewing angle.

FIG. 6 is a perspective view of the first terminal group in FIG. 5.

FIG. 7 is a perspective view of the first grounding sheet in FIG. 5.

FIG. 8 is a perspective view of the first terminal group in FIG. 5 after insert-molded with an insulating block.

FIG. 9 is a chart of simulation analysis of far-end crosstalk (FEXT) of the electrical connector according to certain embodiments of the present invention.

FIG. 10 is an exploded view of a row of terminals and a grounding sheet of an electrical connector in the prior art.

FIG. 11 is a plain view of a row of terminals connected to a grounding sheet of an electrical connector in the prior art.

FIG. 12 is a chart of simulation analysis of FEXT of the electrical connector in the prior art.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated. As used herein, the terms “comprising”, “including”, “carrying”, “having”, “containing”, “involving”, and the like are to be understood to be open-ended, i.e., to mean including but not limited to.

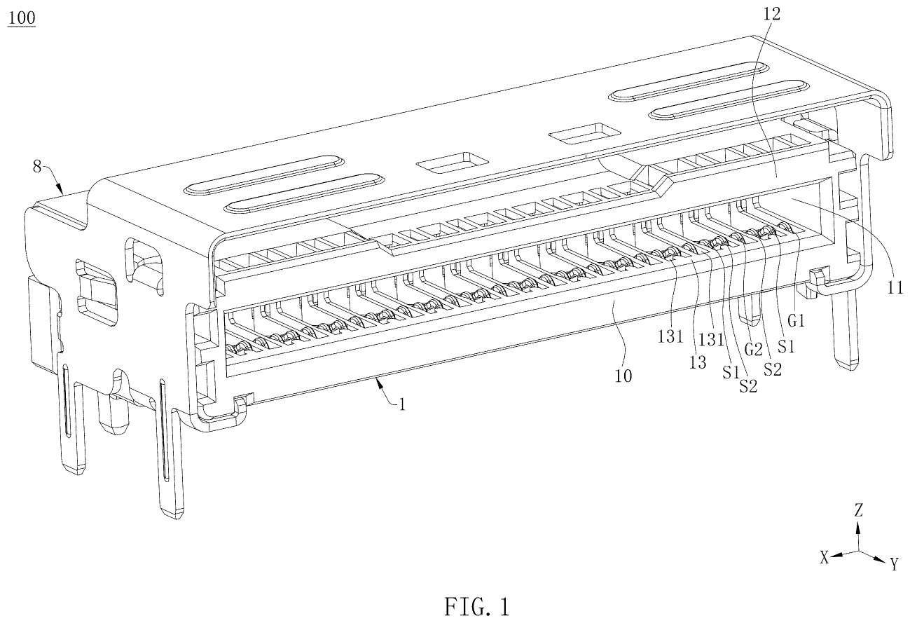

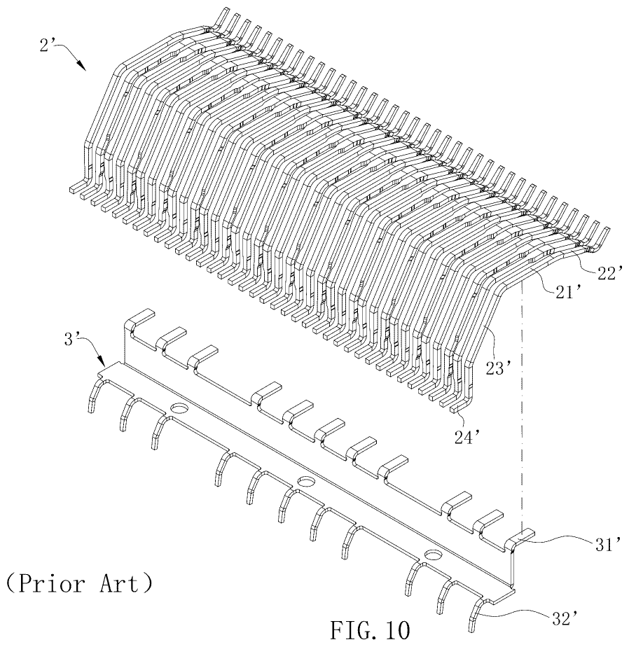

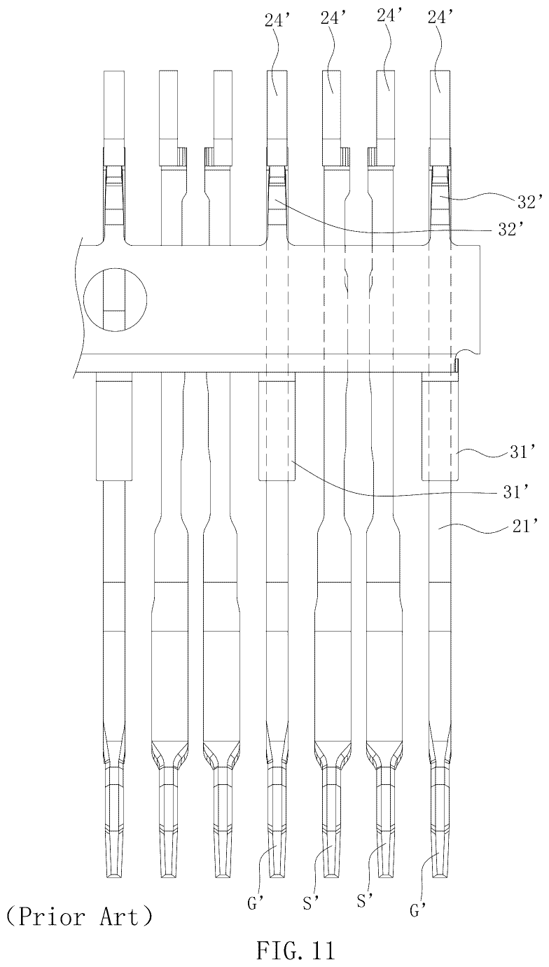

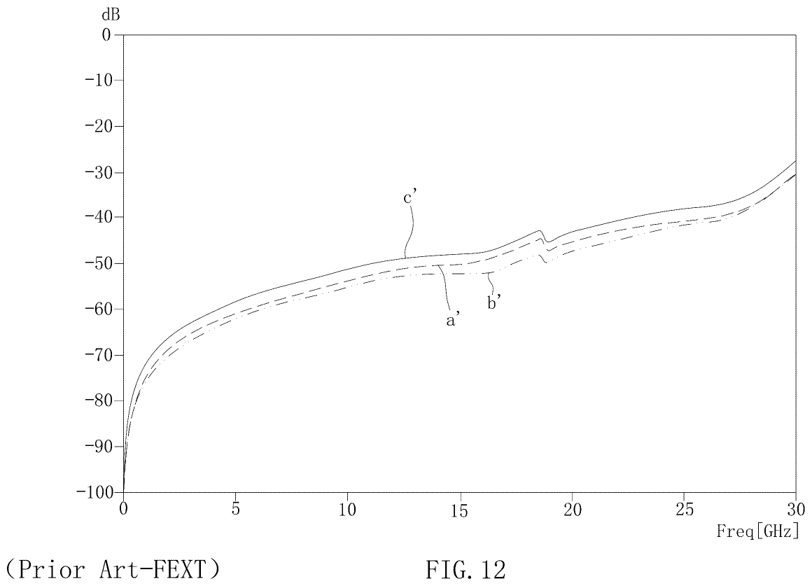

The description will be made as to the embodiments of the present invention in conjunction with the accompanying drawings in FIGS. 1-12. In accordance with the purposes of this invention, as embodied and broadly described herein, this invention, in one aspect, relates to an electrical connector.

To better understand the technical solutions of the present invention, in the three-dimensional coordinates of the accompanying drawings, the Z-axis is defined as a vertical direction, the X-axis is defined as a left-right direction, and the Y-axis is defined as a front-rear direction.

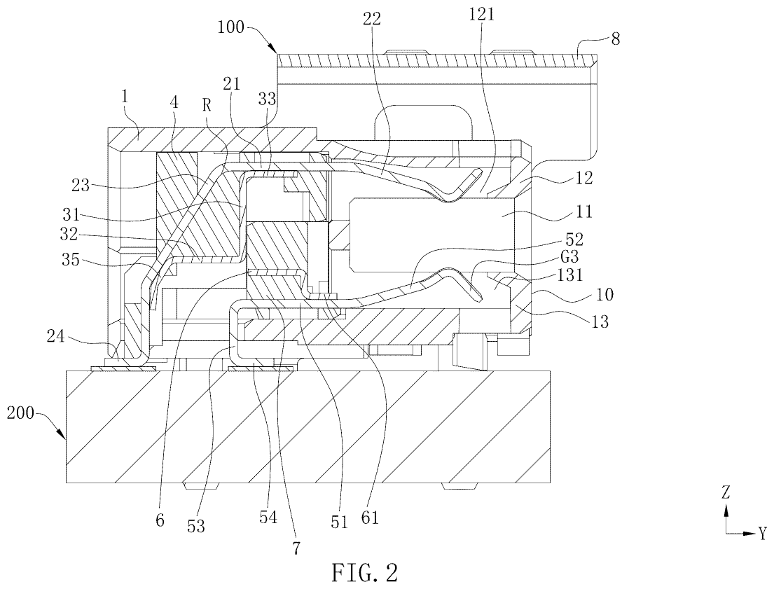

As shown in FIG. 1 and FIG. 2, in certain embodiments of the present invention, the electrical connector 100 includes an insulating body 1, a first terminal group 2 provided in the insulating body 1, a first grounding sheet 3 partially connected to the first terminal group 2, an insulating block 4 insert-molded to and covering the first terminal group 2 and the first grounding sheet 3, a second terminal group 5 opposite to the first terminal group 2 and provided in the insulating body 1, a second grounding sheet 6 partially connected to the second terminal group 5, an insulating seat 7 insert-molded to and covering the second terminal group 5 and the second grounding sheet 6, and a metal shielding shell 8 shielded outside the insulating body 1. The insulating body 1, the insulating block 4 and the insulating seat 7 are formed by insulating plastic materials. The insulating body 1, the insulating block 4 and the insulating seat 7 may be formed by the same material, or may be formed by different materials, and the present invention is not limited thereto. The electrical connector 100 may be a horizontal connector, a vertical connector or other types of connectors. The electrical connector 100 may be connected to a circuit board or may be directly connected to a cable. In the present embodiment, the electrical connector 100 is described as a horizontal connector. In other embodiments, the first grounding sheet 3 may be assembled to the insulating block 4, and the second grounding sheet 6 may be assembled to the insulating seat 7.

As shown in FIG. 1 and FIG. 2, the insulating body 1 has a mating surface 10, an insertion slot 11 formed by recessing from the mating surface 10 along the left-right direction, and a first side wall 12 and a second side wall 13 provided opposite to each other along the vertical direction and at an interval. The insertion slot 11 is formed between the first side wall 12 and the second side wall 13. The first side wall 12 is provided with a plurality of first terminal slots 121 arranged along the left-right direction. The first terminal slots 121 extend along the front-rear direction and are in communication with the insertion slot 11. The second side wall 13 is provided with a plurality of second terminal slots 131 arranged along the left-right direction. The second terminal slots 131 extend along the front-rear direction and are in communication with the insertion slot 11.

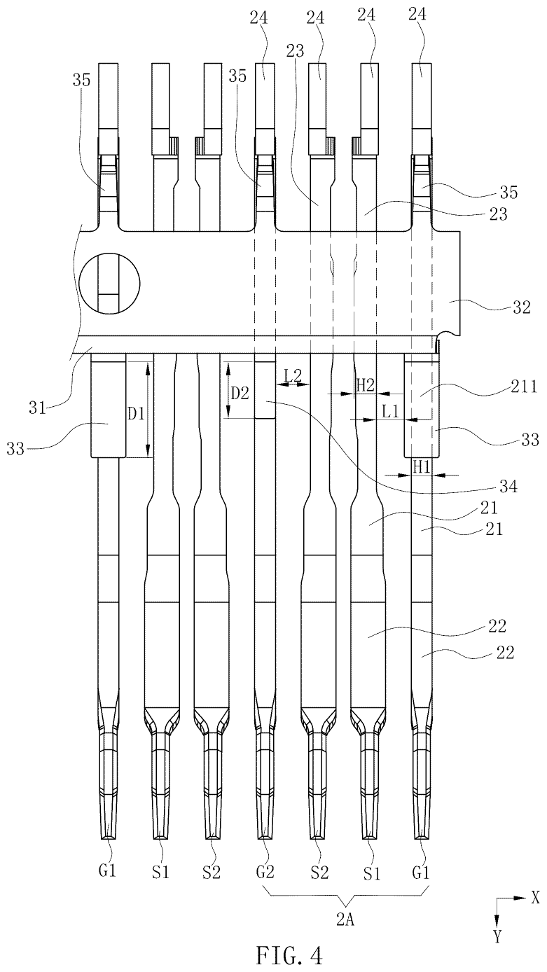

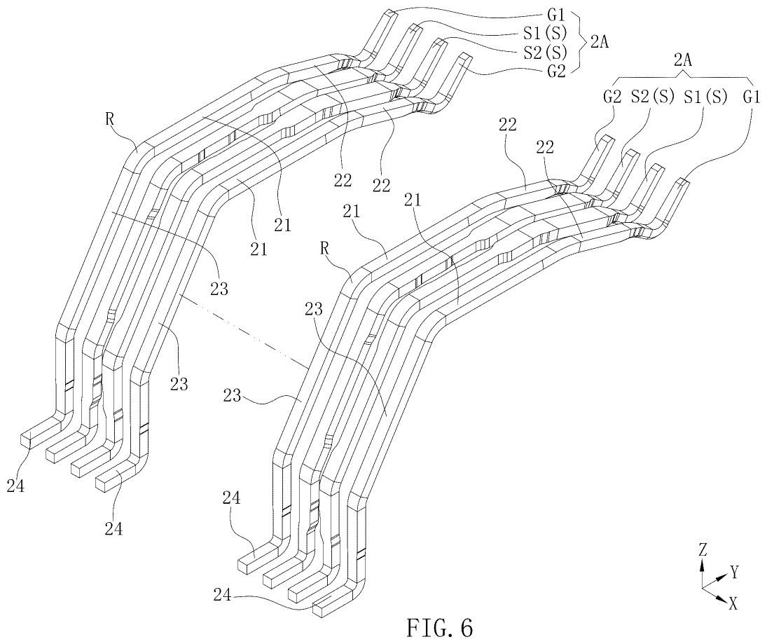

As shown in FIG. 2, FIG. 4 and FIG. 6, the first terminal group 2 is arranged along the left-right direction and is accommodated in the first terminal slots 121. The first terminal group 2 includes a plurality of signal terminals S, a plurality of first ground terminals G1 and a plurality of second ground terminals G2. In the first terminal group 2, two of the signal terminals S, one of the first ground terminals G1 provided to be adjacent to the two signal terminals S at one side along the left-right direction and one of the second ground terminals G2 provided to be adjacent to the two signal terminals S at the other side along the left-right direction form a terminal unit 2A. In the present embodiment, the first grounding terminal G1 and the second grounding terminal G2 are symmetrically arranged in the terminal unit 2A, the first ground terminals G1 and the second ground terminals G2 have identical structures in the terminal unit 2A, and the two signal terminals S in the terminal unit 2A are differential terminals and form a differential terminal pair. In the differential terminal pair, the signal terminal S adjacent to the first ground terminal G1 is defined as a first signal terminal S1, the signal terminal S adjacent to the second ground terminal G2 is defined as a second signal terminal S2, and the first signal terminal S1 and the second signal terminal S2 are provided to be symmetrical in the left-right direction. In other embodiments, the signal terminal S may be a single-ended signal terminal, and one or more signal terminals may exist between the first ground terminal G1 and the second ground terminal G2 in the terminal unit 2A. It is also possible that the first ground terminals G1 and the second ground terminals G2 may have identical substantial structures but different partial structures.

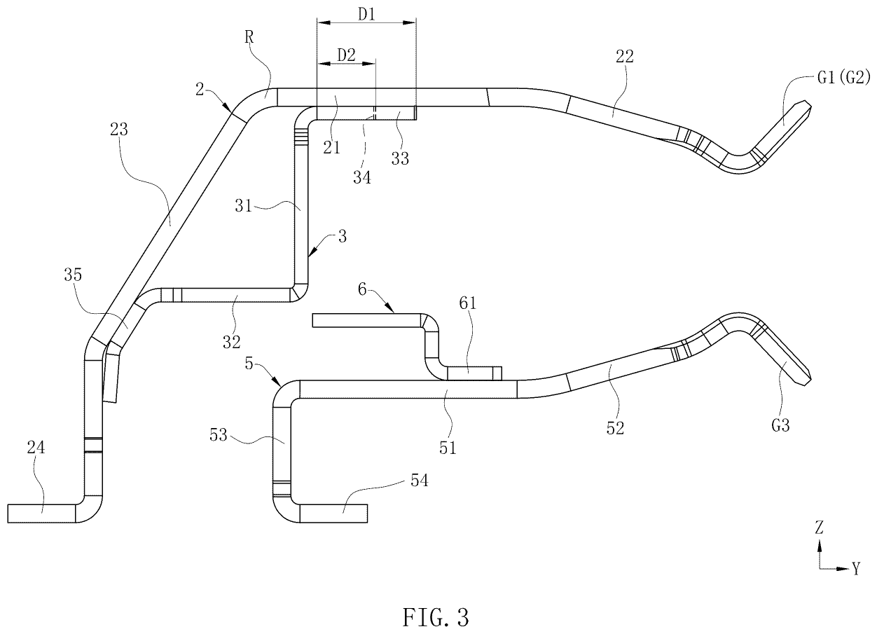

As shown in FIG. 2, FIG. 3 and FIG. 4, each of the first ground terminals G1 and the second ground terminals G2 includes a first flat plate section 21 extending along the front-rear direction, a first elastic arm 22 formed by bending and extending from a front end of the first flat plate section 21, a first connecting section 23 formed by bending and extending from a rear end of the first flat plate section 21 and a first conductive portion 24 connected to the first connecting section 23. A bending portion between the first flat plate section 21 and the first connecting section 23 is defined as a first bending portion R, and the first conductive portion 24 is exposed out of the insulating body 1 to be electrically connected to the circuit board 200. In the present embodiment, the first conductive portion 24 is connected to the circuit board 200 by the surface mount technology (SMT), and in other embodiments, the first conductive portion 24 may be formed by directly extending vertically downward from the first connecting section 23 to be connected to the circuit board 200 by SMT or the dual in-line package (DIP). The first flat plate section 21 of each of the first ground terminals G1 and the second ground terminals G2 has a connecting region 211 connected to the first grounding sheet 3. The shape of the connecting region 211 is a rectangle, and a dimension of the connecting region 211 in the left-right direction is defined as a first dimension H1. A maximum width of a portion of each signal terminal S overlapping with the connecting region 211 of the first ground terminal G1 along the left-right direction is defined as a second dimension H2.

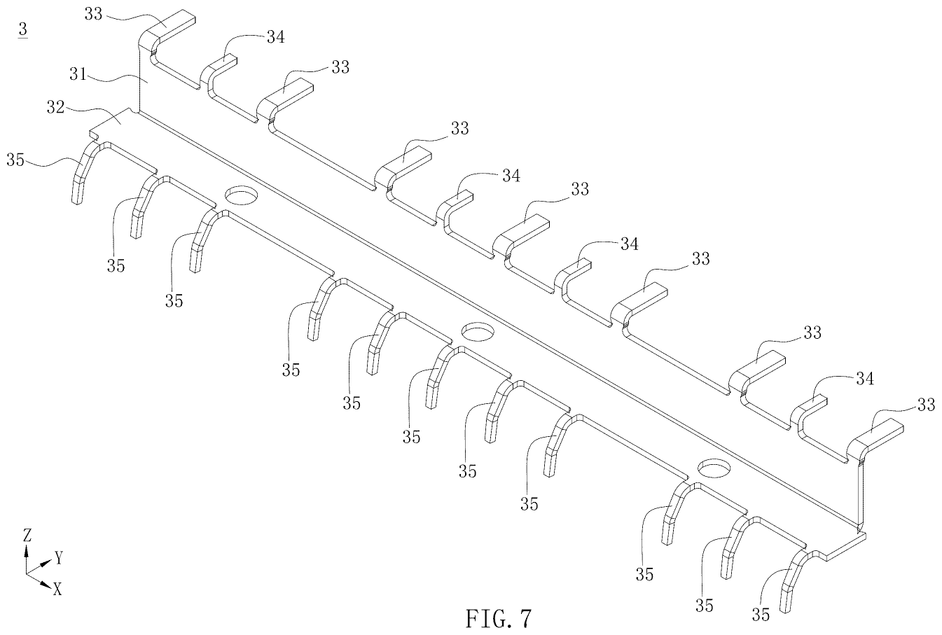

As shown in FIG. 7, in the present embodiment, the first grounding sheet 3 is formed by stamping a metal plate to be connected to the first ground terminals G1 and the second ground terminals G2. The first grounding sheet 3 includes a first plate portion 31 extending in the vertical direction, a second plate portion 32 bending backward from a lower end of the first plate portion 31, a plurality of first connecting portions 33 and a plurality of second connecting portions 34 bending and extending forward from an upper end of the first plate portion 31, and a plurality of third connecting portions 35 bending and extending downward and backward from a rear end of the second plate portion 32. In other embodiments, the first connecting portions 33 and the second connecting portions 34 are protrusion structures or cantilever structures formed by stamping the metal plate forming the first plate portion 31, and the third connecting portions 35 are protrusion structures or cantilever structures formed by stamping the metal plate forming the second plate portion 32.

As shown in FIG. 3 and FIG. 4, the first connecting portions 33 are connected to the first plate portions 31 of the first ground terminals G1, the second dimension H2 is greater than the first dimension H1 corresponding to the first connecting portion 33, and the second connecting portions 34 are connected to the first plate portions 31 of the second ground terminals G2. For the first connecting portion 33 and the second connecting portion 34 correspondingly connected to the first ground terminal G1 and the second ground terminal G2 in a terminal unit 2A, the first connecting portion 33 and the second connecting portion 34 at least partially overlap along the left-right direction. In the present embodiment, the first connecting portions 33 and the second connecting portions 34 are flat plate structures extending in the front-rear direction, such that the first connecting portions 33 are in surface contact with the first ground terminals G1, and the second connecting portions 34 are in surface contact with the second ground terminals G2. At least one portion of the first connecting portion 33 and at least one portion of the second connecting portion 34 are located at a same height in a vertical direction.

As shown in FIG. 3 and FIG. 4, in the present embodiment, two signal terminals S exist between the first ground terminal G1 and the second ground terminal G2 in a terminal unit 2A and are respectively defined as the first signal terminal S1 and the second signal terminal S2. A distance between the first connecting portion 33 and the first signal terminal S1 in the left-right direction is not equal to a distance between the second connecting portion 34 and the second signal terminal S2 in the left-right direction. Specifically, a width of each first connecting portion 33 in the left-right direction is greater than a width of each second connecting portion 34 in the left-right direction. The distance between the first connecting portion 33 and the first signal terminal S1 in the left-right direction is defined as a first distance L1, the distance between the second connecting portion 34 and the second signal terminal S2 in the left-right direction is defined as a second distance L2, and the first distance L1 is less than the second distance L2. An area of a surface of the first connecting portion 33 at a side adjacent to the first signal terminal S1 along the left-right direction is not equal to an area of a surface of the second connecting portion 34 at a side adjacent to the second signal terminal S2 along the left-right direction. Specifically, a length of each first connecting portion 33 in the front-rear direction is defined as a first length D1, a length of each second connecting portion 34 in the front-rear direction is defined as a second length D2, and the first length D1 is greater than the second length D2, thereby resulting in an area of a side of the first connecting portion 33 adjacent to the adjacent first signal terminal S1 to be greater than an area of a side of the second connecting portion 34 adjacent to the adjacent second signal terminal S2. In other embodiments, the width of each first connecting portion 33 in the left-right direction is not equal to the width of each second connecting portion 34 in the left-right direction, or the length of each first connecting portion 33 in the front-rear direction is not equal to the length of each second connecting portion 34 in the front-rear direction, and it is possible that both conditions are satisfied.

As shown in FIG. 3 and FIG. 4, each first connecting portion 33 is connected to the first flat plate section 21 of the corresponding first ground terminal G1 and is located closer to a rear end of the first flat plate section 21, so the first connecting portion 33 is farther away from the first elastic arm 22 relative to the first bending portion R of the first ground terminal G1, and each second connecting portion 34 is connected to the first flat plate section 21 of the corresponding second ground terminal G2 and is located closer to a rear end of the first flat plate section 21, so the second connecting portion 34 is farther away from the first elastic arm 22 relative to the first bending portion R of the second ground terminal G2. In addition, the respective extending lengths of each first connecting portion 33 and each second connecting portion 34 in the front-rear direction do not exceed one half of a length of the corresponding first flat plate section 21 in the front-rear direction, a dimension of each first connecting portion 33 in the left-right direction is greater than the first dimension H1 corresponding to the first connecting portion 33, and a dimension of each second connecting portion 34 in the left-right direction is not greater than the first dimension H1 corresponding to the second connecting portion 34.

As shown in FIG. 3 and FIG. 4, the third connecting portions 35 are respectively connected to the first ground terminals G1 and the second ground terminals G2 correspondingly. Specifically, each third connecting portion 35 is connected to the first connecting section 23, and the shape of each third connecting portion 35 corresponds to the shape of the connecting location of the first connecting section 23. In addition, in the present embodiment, a width of each third connecting portion 35 in the left-right direction is less than the width of each first connecting portion 33 in the left-right direction.

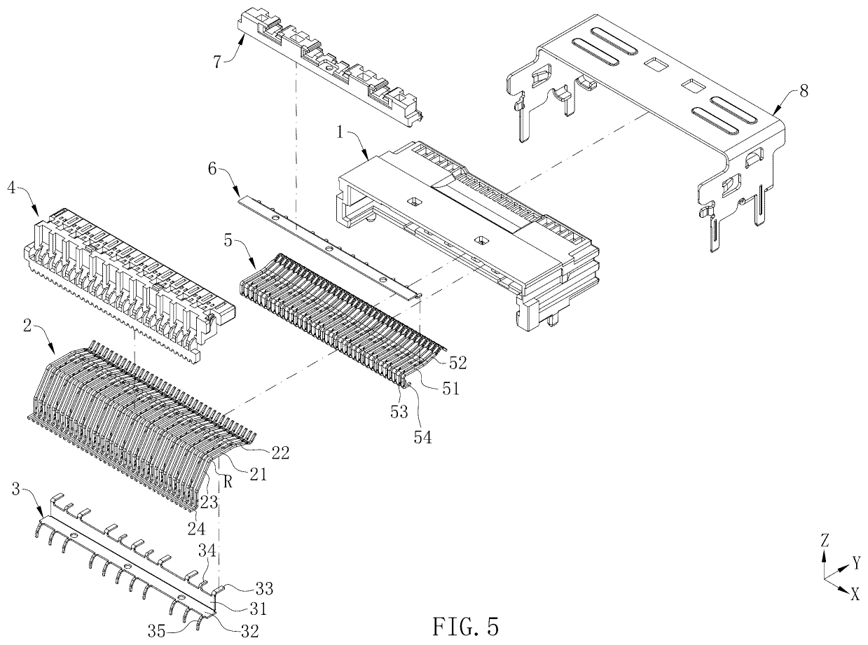

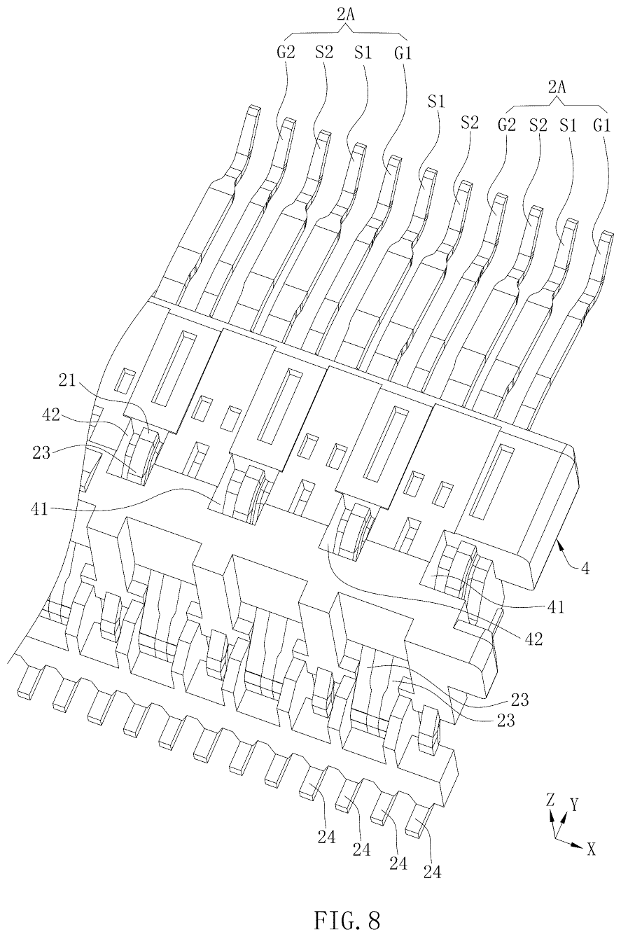

As shown in FIG. 5 and FIG. 8, in the present embodiment, the insulating block 4 includes a plurality of first plastic slots 41 provided to correspond to the first ground terminals G1 and a plurality of second plastic slots 42 provided to correspond to the second ground terminals G2 in a vertical direction. In addition, the first bending portion R of each first ground terminal G1 is exposed from the corresponding first plastic slot 41, and the first bending portion R of each second ground terminal G2 is exposed from the corresponding second plastic slot 42. A width of each first plastic slot 41 in the left-right direction is greater than a width of each second plastic slot 42 in the left-right direction, and a length of each first plastic slot 41 in the front-rear direction is substantially equal to a length of each second plastic slot 42 in the front-rear direction. In one terminal unit 2A, one of the two sides of the two signal terminals S is the corresponding first plastic slot 41, and the other of the two sides thereof is the corresponding second plastic slot 42. In other embodiments, the length of each first plastic slot 41 in the front-rear direction is greater than the length of each second plastic slot 42 in the front-rear direction, and the width of each first plastic slot 41 in the left-right direction is substantially equal to the width of each second plastic slot 42 in the left-right direction. Alternatively, the width and length of each first plastic slot 41 may be both greater than the width and length of each second plastic slot 42.

As shown in FIG. 2 and FIG. 5, the second terminal group 5 is arranged along the left-right direction and is accommodated in the second terminal slots 131. The second terminal group 5 includes a plurality of signal terminals (not numbered) and a plurality of third ground terminals G3. Each third ground terminal G3 includes a second flat plate section 51, a second elastic arm 52 bending and extending from a front end of the second flat plate section 51, a second connecting section 53 bending and extending from a rear end of the second flat plate section 51 and a second conductive portion 54 bending from and connected to the second connecting section 53. The second conductive portion 54 is exposed out of the insulating body 1 to be electrically connected to the circuit board 200. In the present embodiment, the second conductive portion 54 is connected to the circuit board 200 by SMT, and in other embodiments, the second conductive portion 54 may be formed by directly extending vertically downward from the second connecting section 53 to be connected to the circuit board 200 by SMT or DIP. The first elastic arm 22 is located above the second elastic arm 52, and the first elastic arm 22 and the second elastic arm 52 are provided opposite to each other in the vertical direction. The first flat plate section 21 is located above the second flat plate section 51, and the first flat plate section 21 and the second flat plate section 51 are provided opposite to each other in the vertical direction. The first conductive portion 24 is located behind the second conductive portion 54, and the first conductive portion 24 and the second conductive portion 54 are provided opposite to each other in the front-rear direction. The first grounding sheet 3 is provided between the first terminal group 2 and the second terminal group 5, and the first grounding sheet 3 is in contact with the first ground terminals G1 and the second ground terminals G2 and is not in contact with the third ground terminals G3.

As shown in FIG. 2 and FIG. 5, in the present embodiment, the second grounding sheet 6 is formed by stamping a metal plate. The second grounding sheet 6 includes a plurality of fourth connecting portions 61 extending along the front-rear direction, and the fourth connecting portions 61 are flat plate structures, such that the fourth connecting portions 61 are in surface contact with the third ground terminals G3. In other embodiments, the second terminal group 5 adopts the identical definition and arrangement to the first terminal group 2, and the second grounding sheet 6 and the connecting structures of the third ground terminals G3 in the second terminal group 5 may be consistent with the first grounding sheet 3 and the connecting structures of the first ground terminals G1 and the second ground terminals G2. The fourth connecting portions 34 are protrusion structures or cantilever structures formed by stamping the metal plate forming the second plate portion 32. The second grounding sheet 6 is formed by a conductive material, such as a metal material, a conductive plastic, etc.

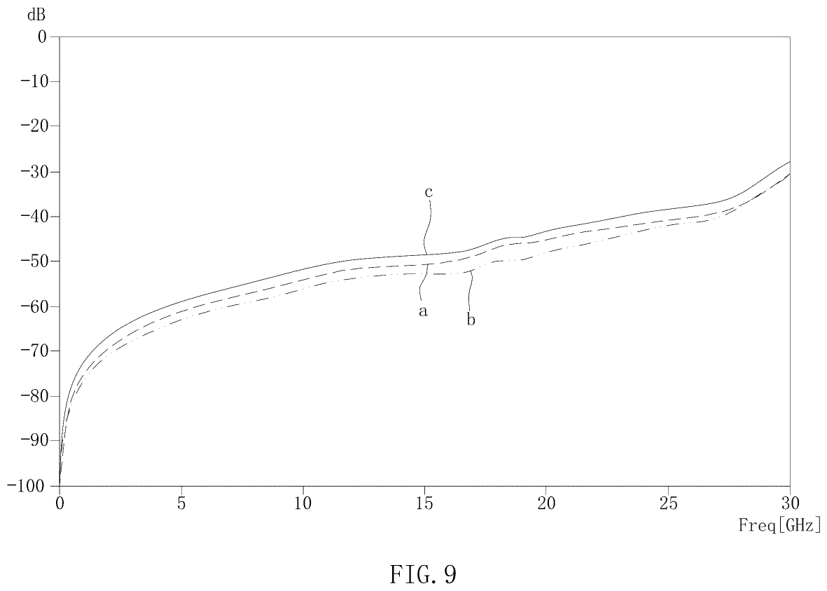

FIG. 9 is a chart of simulation analysis of FEXT of the electrical connector according to certain embodiments of the present invention. The dashed line curve a and the dashed line curve b represent the resonance curves of the first ground terminal G1 and the second ground terminal G2 of the terminal unit 2A, and the solid line curve c represents the superposition of the resonance curves of the first ground terminal G1 and the second ground terminal G2 of the terminal unit 2A. From the analysis chart, it can be seen that in the frequency range of 15-20 GHz, the abrupt peaks of the brown curve and the red curve have different values on the horizontal axis (frequency). The abrupt peak of the red curve is substantially at −50 dB on the vertical axis (resonance), the abrupt peak of the brown curve is less than −45 dB on the vertical axis (resonance), and the abrupt peak of the blue curve is substantially at −45 dB on the vertical axis (resonance), which are reduced compared to the resonances in the prior art.

In sum, the present invention has the following beneficial effects:

1. The distance between the first connecting portion 33 and the first signal terminal S1 in the left-right direction is not equal to the distance between the second connecting portion 34 and the second signal terminal S2 in the left-right direction, or an area of a surface of the first connecting portion 33 at a side adjacent to the first signal terminal S1 along the left-right direction is not equal to an area of a surface of the second connecting portion 34 at a side adjacent to the second signal terminal S2 along the left-right direction, such that the first ground terminal G1 and the second ground terminal G2 have different resonant frequencies, and in the FEXT test curve, the resonance amplitude values on the vertical axis are less than the resonance amplitude values of the electrical connector in the prior art. In addition, the frequencies of the abrupt peaks of the FEXT curves of the electrical connector 100 are different from each other, thus preventing from the superposition of the abrupt peaks of the FEXT curves on the same frequency point that affects the signal transmission, and ensuring the high speed signal transmission of the electrical connector 100.

2. The width of each first connecting portion 33 in the left-right direction is greater than the width of each second connecting portion 34 in the left-right direction, and the distance between the first connecting portion 33 and the first signal terminal S1 in the left-right direction is less than the distance between the second connecting portion 34 and the second signal terminal S2 in the left-right direction. The distance between the second connecting portion 34 and the second signal terminal S2 is greater, thus resulting in the capacitance between the second connecting portion 34 and the second signal terminal S2 to be less than the capacitance between the first connecting portion 33 and the first signal terminal S1. The capacitance and resonance of the electrical connector 100 are directly proportional, and reducing the capacitance results in the reduced resonance, thereby achieving the effect of attenuating the resonance.

3. The extending length of the first connecting portion 33 in the front-rear direction is greater than the extending length of the second connecting portion 34 in the front-rear direction, and the area of a side of the first connecting portion 33 adjacent to the first signal terminal S1 is greater than an area of a side of the second connecting portion 34 adjacent to the second signal terminal S2. The area of a side surface of the second connecting portion 34 adjacent to the second signal terminal S2 is small, thus resulting in the capacitance between the second connecting portion 34 and the second signal terminal S2 to be less than the capacitance between the first connecting portion 33 and the first signal terminal S1. The capacitance and resonance of the electrical connector 100 are directly proportional, and reducing the capacitance results in the reduced resonance, thereby achieving the effect of attenuating the resonance.

4. The first bending portion R is substantially at the location of the resonant point. Thus, the resonance value of the first bending portion R is higher. The first bending portion R of each first ground terminal G1 is exposed from the corresponding first plastic slot 41, and the first bending portion R of each second ground terminal G2 is exposed from the corresponding second plastic slot 42. The first bending portion R is not covered by the plastic, such that the capacitance of the first bending portion R is reduced, and the capacitance of the electrical connector 100 is reduced, thus resulting in the reduced resonance, thereby improving the transmission effect of the electrical connector 100.

5. The first connecting portions 33 and the second connecting portions 34 are flat plate structures extending in the front-rear direction to facilitate the surface contact with the corresponding first flat plate sections 21. In addition, the respective extending lengths of each first connecting portion 33 and each second connecting portion 34 in the front-rear direction do not exceed one half of a length of the corresponding first flat plate section 21 in the front-rear direction, thus preventing the capacitances of the first ground terminals G1 and the second ground terminals G2 from being excessively large and the resonance from being increased, which may affect the signal transmission.

6. The insulating block 4 includes the first plastic slots 41 provided to correspond to the first ground terminals G1 and the second plastic slots 42 provided to correspond to the second ground terminals G2, and the width of each first plastic slot 41 in the left-right direction is greater than the width of each second plastic slot 42, such that the plastic around the second ground terminals G2 is increased, and the capacitance thereof is increased, thus reducing the crosstalk of the electrical connector 100.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector, comprising:
an insulating body;
a first terminal group provided in the insulating body, wherein the first terminal group is arranged along a left-right direction and comprises at least one terminal unit, the terminal unit comprises a first ground terminal, a second ground terminal and at least one signal terminal located between the first ground terminal and the second ground terminal along the left-right direction; and
a first grounding sheet, electrically connected to the first ground terminal and the second ground terminal, wherein the first grounding sheet comprises at least one first connecting portion and at least one second connecting portion, the first connecting portion is electrically connected to the first ground terminal, and the second connecting portion is electrically connected to the second ground terminal;
wherein in one of the at least one terminal unit, the first connecting portion and the second connecting portion electrically connected to the first ground terminal and the second ground terminal at least partially overlap along the left-right direction, a distance between the first connecting portion and a closest one of the at least one signal terminal in the left-right direction is not equal to a distance between the second connecting portion and a closest one of the at least one signal terminal in the left-right direction, or an area of a surface of the first connecting portion at a side adjacent to the at least one signal terminal along the left-right direction is not equal to an area of a surface of the second connecting portion at a side adjacent to the at least one signal terminal along the left-right direction.

2. The electrical connector according to claim 1, wherein the first connecting portion and the second connecting portion are flat plate structures extending in the front-rear direction, the first connecting portion is in surface contact with the first ground terminal, the second connecting portion is in surface contact with the second ground terminal, and an extending length of the first connecting portion in the front-rear direction is greater than an extending length of the second connecting portion in the front-rear direction.

3. The electrical connector according to claim 1, wherein the distance between the first connecting portion and the closest one of the at least one signal terminal in the left-right direction is less than the distance between the second connecting portion and the closest one of the at least one signal terminal in the left-right direction.

4. The electrical connector according to claim 1, wherein a width of the first connecting portion in the left-right direction is greater than a width of the second connecting portion in the left-right direction.

5. The electrical connector according to claim 4, wherein the first ground terminal and the second ground terminal have identical structures, each of the first ground terminal and the second ground terminal comprises a first flat plate section, a first elastic arm formed by bending and extending from a front end of the first flat plate section, a first connecting section formed by bending and extending from a rear end of the first flat plate section and a first conductive portion connected to the first connecting section, the first conductive portion is exposed out of the insulating body to be electrically connected to a circuit board, a portion of the first flat plate section of each of the first ground terminal and the second ground terminal configured to be respectively in contact with the first connecting portion and the second connecting portion is defined as a connecting region, the connecting region has a first dimension in the left-right direction, a dimension of the first connecting portion in the left-right direction is greater than the first dimension corresponding to the first connecting portion, and a dimension of the second connecting portion in the left-right direction is not greater than the first dimension corresponding to the second connecting portion.

6. The electrical connector according to claim 5, wherein a maximum width of a portion of the signal terminal overlapping with the connecting region of the first ground terminal along the left-right direction is defined as a second dimension, and the second dimension is greater than the first dimension corresponding to the first connecting portion.

7. The electrical connector according to claim 1, wherein the first terminal group is insert-molded to an insulating block, the insulating block comprises a first plastic slot provided to correspond to the first ground terminal and a second plastic slot provided to correspond to the second ground terminal in a vertical direction, and widths of the first plastic slot and the second plastic slot in the left-right direction or lengths of the first plastic slot and the second plastic slot in the front-rear direction are different from each other.

8. The electrical connector according to claim 7, wherein each of the first ground terminal and the second ground terminal comprises a first flat plate section, a first elastic arm formed by bending and extending from a front end of the first flat plate section and a first connecting section formed by bending and extending from a rear end of the first flat plate section, a bending portion between the first flat plate section and the first connecting section is defined as a first bending portion, the first bending portion of the first ground terminal is exposed in the first plastic slot, and the first bending portion of the second ground terminal is exposed in the second plastic slot.

9. The electrical connector according to claim 8, wherein the first connecting portion is in contact with the first flat plate section of the first ground terminal, the second connecting portion is in contact with the first flat plate section of the second ground terminal, the first connecting portion is farther away from the first elastic arm relative to the first bending portion of the first ground terminal, and the second connecting portion is farther away from the first elastic arm relative to the first bending portion of the second ground terminal.

10. The electrical connector according to claim 7, wherein a width of the first connecting portion in the left-right direction is greater than a width of the second connecting portion in the left-right direction, the first ground terminal and the second ground terminal are respectively exposed in the first plastic slot and the second plastic slot, and a width of the first plastic slot in the left-right direction is greater than a width of the second plastic slot in the left-right direction or a length of the first plastic slot in the front-rear direction is greater than a length of the second plastic slot in the front-rear direction.

11. The electrical connector according to claim 1, wherein
the at least one signal terminal comprises a differential terminal pair formed by two differential signal terminals, in the differential terminal pair, one of the two differential signal terminals adjacent to the first ground terminal is defined as a first signal terminal, and the other of the two differential signal terminals adjacent to the second ground terminal is defined as a second signal terminal; or
the at least one signal terminal is a single-ended signal terminal, and the single-ended signal terminal is located between the first ground terminal and the second ground terminal.

12. The electrical connector according to claim 1, further comprising a second terminal group, provided in the insulating body, wherein the second terminal group is arranged along the left-right direction, the second terminal group comprises a plurality of third ground terminals, each of the first ground terminal and the second ground terminal comprises a first flat plate section, a first elastic arm bending and extending from a front end of the first flat plate section, a first connecting section bending and extending from a rear end of the first flat plate section and a first conductive portion bending from and connected to the first connecting section, the first conductive portion is exposed out of the insulating body to be electrically connected to a circuit board, each of the third ground terminals comprises a second flat plate section, a second elastic arm bending and extending from a front end of the second flat plate section, a second connecting section bending and extending from a rear end of the second flat plate section and a second conductive portion bending from and connected to the second connecting section, the second conductive portion is exposed out of the insulating body to be electrically connected to the circuit board, the first flat plate section is located above the second flat plate section, the first flat plate section and the second flat plate section are provided opposite to each other in a vertical direction, the first conductive portion is located behind the second conductive portion, the first conductive portion and the second conductive portion are provided opposite to each other in the front-rear direction, the first grounding sheet is provided between the first terminal group and the second terminal group, and the first grounding sheet is in contact with the first ground terminal and the second ground terminal and is not in contact with the third ground terminals.

13. A grounding sheet structure in an electrical connector, the grounding sheet structure comprising:
a first plate portion; and
at least one first connecting portion and at least one second connecting portion extending from the first plate portion, wherein the first connecting portion and the second connecting portion are electrically connected to a ground terminal of the electrical connector respectively, and the first connecting portion and the second connecting portion are arranged along a left-right direction;
wherein viewing along a vertical direction, locations of at least one portion of the first connecting portion and at least one portion of the second connecting portion are identical in a front-rear direction, an extending length of the first connecting portion in the front-rear direction and an extending length of the second connecting portion in the front-rear direction are not identical, or a width of the first connecting portion in the left-right direction and a width of the second connecting portion in the left-right direction are not identical.

14. The grounding sheet structure in the electrical connector according to claim 13, wherein the first connecting portion and the second connecting portion are flat plate structures to be in surface contact with the ground terminals of the electrical connector, and the extending length of the first connecting portion in the front-rear direction is greater than the extending length of the second connecting portion in the front-rear direction.

15. The grounding sheet structure in the electrical connector according to claim 13, wherein a width of the first connecting portion in the left-right direction is greater than a width of the second connecting portion in the left-right direction.

16. The grounding sheet structure in the electrical connector according to claim 13, wherein a dimension of the first connecting portion in the left-right direction is greater than a dimension of the ground terminal connected to the first connecting portion in the left-right direction, and a dimension of the second connecting portion in the left-right direction is less than or equal to a dimension of the ground terminal connected to the second connecting portion in the left-right direction.

17. An electrical connector, comprising:
an insulating body;
a first terminal group provided in the insulating body, wherein the first terminal group is arranged along a left-right direction and comprises at least one terminal unit, the terminal unit comprises a first ground terminal, a second ground terminal and at least one signal terminal located between the first ground terminal and the second ground terminal along the left-right direction; and
a first grounding sheet, comprising at least one first connecting portion and at least one second connecting portion, wherein the first connecting portion is electrically connected to the first ground terminal, and the second connecting portion is electrically connected to the second ground terminal;
wherein at least one portion of the first connecting portion and at least one portion of the second connecting portion electrically connected to the first ground terminal and the second ground terminal in one of the at least one terminal unit are located at a same height in a vertical direction, a distance between the first connecting portion and a closest one of the at least one signal terminal in the left-right direction is not equal to a distance between the second connecting portion and a closest one of the at least one signal terminal in the left-right direction, or an extending length of the first connecting portion in the front-rear direction and an extending length of the second connecting portion in a front-rear direction are not identical.

18. The electrical connector according to claim 17, wherein the first connecting portion and the second connecting portion are flat plate structures extending in the front-rear direction, the first connecting portion is in surface contact with the first ground terminal, the second connecting portion is in surface contact with the second ground terminal, and the extending length of the first connecting portion in the front-rear direction is greater than the extending length of the second connecting portion in the front-rear direction.

19. The electrical connector according to claim 17, wherein a width of the first connecting portion in the left-right direction is greater than a width of the second connecting portion in the left-right direction.

20. The electrical connector according to claim 17, wherein the first ground terminal and the second ground terminal have identical structures, a portion of each of the first ground terminal and the second ground terminal configured to be respectively in contact with the first connecting portion and the second connecting portion is defined as a connecting region, the connecting region has a first dimension in the left-right direction, a dimension of the first connecting portion in the left-right direction is greater than the first dimension corresponding to the first connecting portion, and a dimension of the second connecting portion in the left-right direction is not greater than the first dimension corresponding to the second connecting portion.
